(19) United States
(12) Patent Application Publication
(10) Pub. No.: US 2025/0099919 A1
(43) Pub. Date: Mar. 27, 2025

(54) GAS SEPARATION MEMBRANE

(71) Applicants: NITTO DENKO CORPORATION, Osaka (JP); HIROSHIMA UNIVERSITY, Hiroshima (JP)

(72) Inventors: Toshiyuki KAWASHIMA, Osaka (JP); Shunsuke NOMI, Osaka (JP); Hiroki NAGASAWA, Hiroshima (JP); Toshinori TSURU, Hiroshima (JP); Masakoto KANEZASHI, Hiroshima (JP)

(73) Assignees: NITTO DENKO CORPORATION, Osaka (JP); HIROSHIMA UNIVERSITY, Hiroshima (JP)

(21) Appl. No.: 18/698,139

(22) PCT Filed: May 19, 2022
(86) PCT No.: PCT/JP2022/020821

§ 371 Date: Apr. 3, 2024

(30) Foreign Application Priority Data
Oct. 25, 2021 (JP) 2021-173642

(51) Int. Cl. B01D 71/06; B01D 69/10; B01D 69/12; B01D 71/70

(52) U.S. Cl. CPC B01D 71/06; B01D 69/10; B01D 69/12; B01D 71/701

(57) ABSTRACT

An object of the present invention is to provide a gas separation membrane having more excellent gas separation performance than a conventional gas separation membrane. The gas separation membrane of the present invention has an intermediate layer on a polymer membrane substrate, and has a separation layer on the intermediate layer, where the intermediate layer has a non-porous structure, the separation layer is a silica-based separation layer, and the silica-based separation layer has a different chemical composition or layer structure in a thickness direction.

### TECHNICAL FIELD

The present invention relates to a gas separation membrane.

### BACKGROUND ART

A gas separation membrane (gas separation membrane) that transmits and separates a specific gas from a mixed gas is known.

For example, Patent Document 1 proposes a gas separation membrane having a resin layer containing a compound having a siloxane bond.

As the gas separation membrane, a gas separation membrane having a silica-based separation layer on a porous substrate is known.

As a method for forming the silica-based separation layer, a membrane production method by an atmospheric pressure plasma CVD (Chemical Vapor Deposition) method is known in addition to a membrane production method using a sol-gel method. The atmospheric pressure plasma CVD method is advantageous in that, for example, membrane production can be performed at normal temperature and normal pressure, and a large-area membrane production can be performed by continuous processing because vacuum equipment is unnecessary.

For example, Patent Document 2 proposes a method for manufacturing a gas separation filter in which a separation layer is formed on a porous substrate by an atmospheric pressure plasma chemical vapor deposition method, wherein a mixed gas of nitrogen and argon as a discharge gas is introduced into a discharge unit to generate atmospheric pressure plasma, a volatile organosilicon compound is introduced below the discharge unit to be mixed with the atmospheric pressure plasma, a separation layer is formed on the porous substrate, and nitrogen in the discharge gas is 5.0 vol % or less.

### PRIOR ART DOCUMENTS

### Patent Documents

Patent Document 1: JP-A-2016-163871
Patent Document 2: JP-A-2017-131849

### SUMMARY OF THE INVENTION

### Problems to be Solved by the Invention

However, the conventional gas separation membrane has insufficient gas separation performance, and development of a gas separation membrane having more excellent gas separation performance than a conventional gas separation membrane has been required.

The present invention has been made in view of the above problems, and an object of the present invention is to provide a gas separation membrane having more excellent gas separation performance than a conventional gas separation membrane.

### Means for Solving the Problems

The present invention is related to a gas separation membrane comprising an intermediate layer on a polymer membrane substrate and a separation layer on the intermediate layer, wherein
the intermediate layer has a non-porous structure,
the separation layer is a silica-based separation layer, and
the silica-based separation layer has a different chemical composition or layer structure in a thickness direction.

In the silica-based separation layer, it is preferable that the rate of the inorganic structure increases from the intermediate layer side toward the other side in the thickness direction.

In the silica-based separation layer, it is preferable that the content of an Si atom and an oxygen atom increases and the content of a carbon atom decreases from the intermediate layer side toward the other side in the thickness direction.

It is preferable that O/Si, which is a ratio of the number of oxygen atoms to the number of Si atoms on a surface of the silica-based separation layer, is less than 1.7.

The silica-based separation layer preferably has a multilayer structure.

It is preferable that the silica-based separation layer includes at least a first separation layer laminated on the intermediate layer and a second separation layer laminated on the first separation layer, a content of an Si atom and an oxygen atom in the second separation layer is higher than a content of an Si atom and an oxygen atom in the first separation layer, and a content of a carbon atom in the second separation layer is lower than a content of a carbon atom in the first separation layer.

It is preferable that C/Si, which is a ratio of the number of carbon atoms to the number of Si atoms in the first separation layer, is 1.5 or more and 1.8 or less, and C/Si, which is a ratio of the number of carbon atoms to the number of Si atoms in the second separation layer, is 1.0 or more and less than 1.5.

It is preferable that a raw material of the silica-based separation layer is a volatile organosilicon compound.

It is preferable that the intermediate layer contains polysiloxane.

It is preferable that the polysiloxane is polydimethylsiloxane.

It is preferable that the gas separation membrane preferably has a CO₂ transmittance at 25° C. of 90 GPU or more.

It is preferable that the gas separation membrane preferably has a CO₂/CH₄ transmittance ratio at 25° C. of 15 or more.

### Effect of the Invention

The gas separation membrane of the present invention has silica-based separation layers having different chemical compositions or layer structures in the thickness direction, and is superior in gas separation performance (particularly, CO₂/CH₄ transmittance ratio) to a conventional gas separation membrane. The gas separation membrane of the present invention also has a feature of high gas transmittance (in particular, CO₂ transmittance). When the silica-based separation layer has a rate of the inorganic structure increasing continuously or stepwise from the intermediate layer side toward the other side in the thickness direction, a gas separation membrane having the more excellent effect can be obtained.

### BRIEF DESCRIPTION OF THE DRAWINGS

FIG. 1 is a schematic view of a separation layer membrane production apparatus used in an atmospheric pressure plasma CVD method.

### MODE FOR CARRYING OUT THE INVENTION

Hereinafter, embodiments of the present invention will be described.

### [Gas Separation Membrane]

The gas separation membrane of the present invention has an intermediate layer on a polymer membrane substrate, and has a silica-based separation layer on the intermediate layer, the intermediate layer has a non-porous structure, and the silica-based separation layer has a different chemical composition or layer structure in a thickness direction.

The polymer membrane substrate (support) is not particularly limited as long as it can support the intermediate layer, but is preferably a porous substrate. Examples of the material for forming the polymer membrane substrate include various materials such as polyarylethersulfone such as polysulfone and polyethersulfone, polyester, polyamide, polyimide, silicone, silicone rubber, polyurethane, polyethylene, polypropylene, polystyrene, polycarbonate, polyetheretherketone, polyphenylene oxide, polyacrylonitrile, polyvinyl fluoride, and polyvinylidene fluoride, but, in particular, polysulfone or polyarylethersulfone is preferably used from the viewpoint of being chemically, mechanically, and thermally stable. The thickness of the polymer membrane substrate is usually about 50 to 500 μm, preferably 100 to 200 μm, but is not limited thereto. The polymer membrane substrate may be reinforced by backing with a woven fabric, a nonwoven fabric, or the like.

When the polymer membrane substrate is a porous substrate, the porous substrate may have a symmetric structure or an asymmetric structure, but from the viewpoint of achieving both the supporting function of the intermediate layer and the smoothness of the intermediate layer forming side surface, the porous substrate preferably has an asymmetric structure. The average pore size of the intermediate layer-formed side surface of the porous substrate is preferably 0.01 to 0.5 μm.

The gas separation membrane of the present invention has an intermediate layer between the polymer membrane substrate and the silica-based separation layer from the viewpoint of having the membrane thickness of the silica-based separation layer uniform to improve gas separation performance.

Since the intermediate layer has a non-porous structure, smoothness of the silica-based separation layer can be improved to enhance gas separation performance.

Examples of a material for forming the intermediate layer include polysiloxanes such as polydimethylsiloxane, polydiethylsiloxane, polymethylphenylsiloxane, and polydimethyldiphenylsiloxane; fluororesin such as polytetrafluoroethylene; epoxy resin such as polyethylene oxide; polyimide resin; polysulfone resin; polyacetylene resins such as polytrimethylsilylpropyne and polydiphenylacetylene; and polyolefin resins such as polymethylpentene. Among them, from the viewpoint of improving the gas separation performance and the gas transmittance, polysiloxane is preferably used, and polydimethylsiloxane is more preferably used.

The intermediate layer may contain nanoparticles such as silica particles, titania particles, and alumina particles.

The thickness of the intermediate layer is usually 0.5 to 10 μm, and is preferably 0.5 to 5 μm and more preferably 1 to 3 μm from the viewpoint of improving gas separation performance and gas transmittance.

The silica-based separation layer is a layer having a function of allowing a gas having a small molecular diameter to be transmitted from a mixed gas containing two or more kinds of gases having different molecular diameters, inhibiting the transmission of a gas having a large molecular diameter, and separating gases having different molecular diameters.

The silica-based separation layer has a different chemical composition or layer structure in the thickness direction. In the silica-based separation layer, preferably, the rate of the inorganic structure increases continuously or stepwise from the intermediate layer side toward the other side in the thickness direction, and more preferably, the content of an Si atom and an oxygen atom increases continuously or stepwise from the intermediate layer side toward the other side in the thickness direction, and the content of a carbon atom decreases continuously or stepwise.

O/Si, which is the ratio of the number of oxygen atoms to the number of Si atoms on the surface of the silica-based separation layer, is preferably less than 1.7, more preferably 1.65 or less, and still more preferably 1.60 or less from the viewpoint of improving the gas separation performance and the gas transmittance. The lower limit value of O/Si is usually 1.25 or more, preferably 1.30 or more, and more preferably 1.40 or more.

The silica-based separation layer may have a single-layer structure or a multilayer structure of two or more layers, but, from the viewpoint of improving the gas separation performance and the gas transmittance as well as the viewpoint of easy production, the silica-based separation layer preferably has a multilayer structure of two or more layers, and more preferably has a two-layer structure or a three-layer structure. Specifically, the silica-based separation layer includes at least a first separation layer laminated on the intermediate layer and a second separation layer laminated on the first separation layer, a content of an Si atom and an oxygen atom in the second separation layer is higher than a content of an Si atom and an oxygen atom in the first separation layer, and a content of a carbon atom in the second separation layer is lower than a content of a carbon atom in the first separation layer. When the silica-based separation layer further includes a third or more separation layers on the second separation layer, the contents of Si atoms and oxygen atoms in each of the third or more separation layers gradually increase, and the content of a carbon atom gradually decreases.

From the viewpoint of improving the gas separation performance and the gas transmittance, C/Si, which is the ratio of the number of carbon atoms to the number of Si atoms in the first separation layer, is preferably 1.5 or more and 1.8 or less, and more preferably 1.5 or more and 1.7 or less, and C/Si, which is the ratio of the number of carbon atoms to the number of Si atoms in the second separation layer, is preferably 1.0 or more and less than 1.5, and more preferably 1.2 or more and 1.4 or less.

The thickness (total thickness in case of multilayer structure) of the silica-based separation layer is not particularly limited, but is preferably 0.01 to 2 μm, more preferably 0.1 to 1.5 μm, and still more preferably 0.5 to 1.2 μm from the viewpoint of improving the gas separation performance and the gas transmittance.

The gas separation membrane of the present invention preferably has a CO₂ transmittance at 25° C. of 90 GPU or more, more preferably 95 GPU or more, still more preferably 100 GPU or more, still more preferably 130 GPU or more, still more preferably 150 GPU or more, still more preferably 200 GPU or more, and still more preferably 250 GPU or more.

The gas separation membrane of the present invention preferably has a CO₂ transmittance at 150° C. of 90 GPU or more, more preferably 100 GPU or more, still more preferably 150 GPU or more, still more preferably 200 GPU or more, still more preferably 250 GPU or more, and still more preferably 300 GPU or more.

In the gas separation membrane of the present invention, the CO₂/CH₄ transmittance ratio at 25° C. is preferably 15 or more, more preferably 30 or more, still more preferably 35 or more, and still more preferably 40 or more.

In the gas separation membrane of the present invention, the CO₂/CH₄ transmittance ratio at 150° C. is preferably 9 or more, more preferably 9.5 or more, still more preferably 10 or more, and still more preferably 12 or more.

### [Method for Producing Gas Separation Membrane]

The intermediate layer can be formed by a known method, and can be formed, for example, by applying a composition containing a material for forming the intermediate layer onto the polymer membrane substrate, and drying the composition.

The silica-based separation layer can be formed on the intermediate layer by, for example, an atmospheric pressure plasma CVD method.

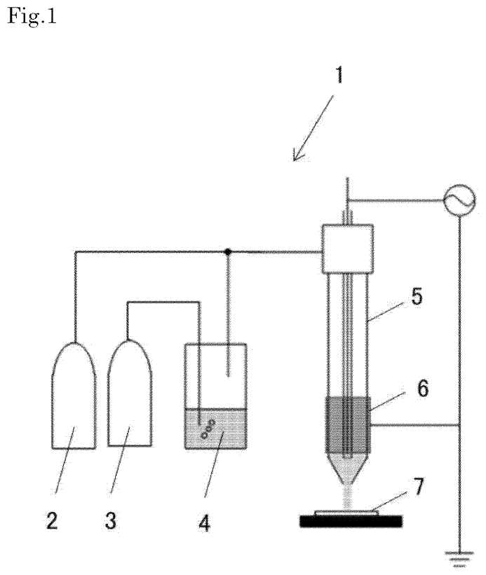

As the separation layer membrane production apparatus used by the atmospheric pressure plasma CVD method, a known separation layer membrane production apparatus can be used, and for example, the separation layer membrane production apparatus 1 shown in FIG. 1 can be used.

The raw material of the silica-based separation layer is not particularly limited as long as chemical vapor deposition can be performed by atmospheric pressure plasma, and examples thereof include volatile organosilicon compounds such as hexamethyldisiloxane, trimethylethoxysilane, and methyltriethoxysilane, and hexamethyldisiloxane is preferable from the viewpoint of improving gas separation performance and gas transmittance.

The discharge gas cylinder 2 is filled with a discharge gas (N₂, Air, O₂, or the like), and the carrier gas cylinder 3 is filled with a carrier gas (Ar or the like). A carrier gas containing a volatile organosilicon compound is obtained by passing the carrier gas through the bubbler 4 containing the liquid volatile organosilicon compound. Then, a mixed gas obtained by mixing a carrier gas containing a volatile organosilicon compound and a discharge gas is supplied to the plasma generator 5. The volatile organosilicon compound is decomposed by the atmospheric pressure plasma generated in the discharge unit 6, and the silica-based separation layer is formed on the polymer membrane substrate 7 having the intermediate layer by chemical vapor deposition. When vapor deposition is performed while moving the polymer membrane substrate 7 having the intermediate layer during membrane production of the silica-based separation layer, a silica-based separation layer having a uniform thickness is obtained. In addition, vapor deposition may be performed a plurality of times (a plurality of cycles) in order to form a silica-based separation layer having a large membrane thickness.

Examples of the method for forming the silica-based separation layer having a different chemical composition or layer structure in the thickness direction include the following methods.

### (1) Method for Continuously or Stepwise Changing Composition of Discharge Gas

By continuously or stepwise changing the composition of the discharge gas, it is possible to form a silica-based separation layer in which the chemical composition or the layer structure is continuously or stepwise different in the thickness direction.

For example, when a silica-based separation layer having a three-layer structure including a first separation layer, a second separation layer, and a third separation layer is formed, N₂ is used as a discharge gas at the time of forming the first separation layer, Air is used as a discharge gas at the time of forming the second separation layer, and O₂ is used as a discharge gas at the time of forming the third separation layer. Alternatively, a discharge gas containing N₂ and O₂ may be used as the discharge gas, and the mixing ratio of N₂ and O₂ may be changed at the time of forming each layer of the first separation layer, the second separation layer, and the third separation layer.

By continuously or stepwise changing the composition of the discharge gas from oxygen lean to oxygen rich, it is possible to form a silica-based separation layer in which the rate of the inorganic structure continuously or stepwise increases from the intermediate layer side toward the other side in the thickness direction, specifically, a silica-based separation layer in which the content of an Si atom and an oxygen atom continuously or stepwise increases and the content of a carbon atom continuously or stepwise decreases from the intermediate layer side toward the other side in the thickness direction. The silica-based separation layer is more excellent in gas separation performance and gas transmittance.

### (2) Method for Continuously or Stepwise Changing Concentration of Volatile Organosilicon Compound in Mixed Gas

By continuously or stepwise changing the concentration of the volatile organosilicon compound in the mixed gas, it is possible to form a silica-based separation layer having a chemical composition or a layer structure different continuously or stepwise in the thickness direction.

For example, when a silica-based separation layer having a two-layer structure including a first separation layer and a second separation layer is formed, the concentration of the volatile organosilicon compound is increased (for example, 125 to 800 ppm) at the time of forming the first separation layer, and the concentration of the volatile organosilicon compound is decreased (for example, 50 to 100 ppm) at the time of forming the second separation layer.

By continuously or stepwise decreasing the concentration of the volatile organosilicon compound in the mixed gas, it is possible to form a silica-based separation layer in which the rate of the inorganic structure continuously or stepwise increases from the intermediate layer side toward the other side in the thickness direction, specifically, a silica-based separation layer in which the content of an Si atom and an oxygen atom continuously or stepwise increases and the content of a carbon atom continuously or stepwise decreases from the intermediate layer side toward the other side in the thickness direction. The silica-based separation layer is more excellent in gas separation performance and gas transmittance.

After the silica-based separation layer is formed on the intermediate layer, heat treatment (annealing) may be performed.

The gas separation membrane of the present invention is not limited in its shape in any way. That is, any conceivable membrane shape such as a flat membrane shape, a cylindrical shape or a spiral element shape is employable.

### EXAMPLES

Hereinafter, the present invention will be described with reference to Examples, but the present invention is not limited to these Examples.

### Example 1

A coating liquid containing polydimethylsiloxane (PDMS) was applied onto a porous polysulfone support (CF-30K, manufactured by Nitto Denko Corporation) by a spin coating method, and dried to form an intermediate layer (thickness: 3 μm).

A silica-based separation layer (total thickness: 1.2 μm) having a two-layer structure including a first separation layer (thickness: 400 nm) and a second separation layer (thickness: 800 nm) was formed on the intermediate layer by an atmospheric pressure plasma CVD method by membrane production under the production conditions described in Table 2 using a separation layer membrane production apparatus to produce a gas separation membrane.

Elemental analysis of the silica-based separation layer and evaluation of gas transmission of the gas separation membrane were performed by the following methods. The results are shown in Table 1.

In the silica-based separation layer of Example 1, the content of an Si atom and an oxygen atom in the second separation layer was higher than that in the first separation layer. Conversely, the content of a carbon atom in the second separation layer was lower than that in the first separation layer. That is, in the silica-based separation layer of Example 1, the rate of the inorganic structure of the second separation layer was higher than that of the first separation layer.

### Examples 2 to 4

A gas separation membrane was produced in the same manner as in Example 1 except that the production conditions shown in Table 2 were employed in the membrane production of the silica-based separation layer.

Elemental analysis of the silica-based separation layer and evaluation of gas transmission of the gas separation membrane were performed by the following methods. The results are shown in Table 1.

In the silica-based separation layer of Examples 2 to 4, the content of an Si atom and an oxygen atom in the second separation layer was higher than that in the first separation layer. Conversely, the content of a carbon atom in the second separation layer was lower than that in the first separation layer. That is, in the silica-based separation layer of Example 2 to 4, the rate of the inorganic structure was higher in the second separation layer than that in the first separation layer.

### Comparative Example 1

A silica-based separation layer (total thickness: 1.2 μm) having a two-layer structure including a first separation layer (thickness: 400 nm) and a second separation layer (thickness: 800 nm) was formed on a porous polysulfone support (CF-30K, manufactured by Nitto Denko Corporation) by an atmospheric pressure plasma CVD method using a separation layer forming apparatus by membrane production under the production conditions described in Table 2 to produce a gas separation membrane.

Elemental analysis of the silica-based separation layer and evaluation of gas transmission of the gas separation membrane were performed by the following methods. The results are shown in Table 1.

In the silica-based separation layer of Comparative Example 1, the content of an Si atom and an oxygen atom in the second separation layer was higher than that in the first separation layer. Conversely, the content of a carbon atom in the second separation layer was lower than that in the first separation layer. That is, in the silica-based separation layer of Comparative Example 1, the rate of the inorganic structure in the second separation layer was higher than that in the first separation layer.

### Comparative Example 2

A coating liquid containing polydimethylsiloxane (PDMS) was applied onto a porous polysulfone support (CF-30K, manufactured by Nitto Denko Corporation) by a spin coating method, and dried to form an intermediate layer (thickness: 3 μm). Thereafter, the surface of the formed intermediate layer was irradiated with plasma under the conditions described in Table 2, and the surface of the intermediate layer was modified to form a separation layer, thereby manufacturing a gas separation membrane.

The gas transmission of the gas separation membrane was evaluated by the following method. The results are shown in Table 1.

In the intermediate layer including the separation layer of Comparative Example 2, the content of an Si atom and an oxygen atom was higher on the surface of the separation layer than that in the middle of the intermediate layer. Conversely, the content of a carbon atom was lower on the surface of the separation layer than that in the middle of the intermediate layer. That is, in the intermediate layer including the separation layer of Comparative Example 2, the rate of the inorganic structure was higher on the surface of the separation layer than that in the middle of the intermediate layer.

### Comparative Examples 3 and 4

A coating liquid containing polydimethylsiloxane (PDMS) was applied onto a porous polysulfone support (CF-30K manufactured by Nitto Denko Corporation) by a spin coating method, and dried to form an intermediate layer (thickness: 5 μm).

A single silica-based separation layer (thickness: 1.2 μm) was formed on the intermediate layer by an atmospheric pressure plasma CVD method by membrane production under the production conditions described in Table 2 using a separation layer membrane production apparatus to produce a gas separation membrane.

Elemental analysis of the silica-based separation layer and evaluation of gas transmission of the gas separation membrane were performed by the following methods. The results are shown in Table 1.

The silica-based separation layers of Comparative Examples 3 and 4 had the same contents of Si atoms, oxygen atoms, and carbon atoms in the thickness direction.

### Comparative Example 5

A gas separation membrane was produced in the same manner as in Comparative Example 1 except that a NF membrane made of sulfonated polyethersulfone (NTR-7410 manufactured by Nitto Denko Corporation) was used as a support instead of the porous polysulfone support (CF-30K manufactured by Nitto Denko Corporation), and the silica-based separation layer was formed by membrane production under the production conditions described in Table 2.

Elemental analysis of the silica-based separation layer and evaluation of gas transmission of the gas separation membrane were performed by the following methods. The results are shown in Table 1.

In the silica-based separation layer of Comparative Example 5, the content of an Si atom and an oxygen atom in the second separation layer was higher than that in the first separation layer. Conversely, the content of a carbon atom in the second separation layer was lower than that in the first separation layer. That is, in the silica-based separation layer of Comparative Example 5, the rate of the inorganic structure in the second separation layer was higher than that in the first separation layer.

### [Measurement and Evaluation Method]

### (Elemental Analysis of Silica-Based Separation Layer)

Elemental analysis of the silica-based separation layer was performed using X-ray electron spectroscopy. A silicon wafer was used as a substrate, and under the same conditions as those for membrane production on the porous support, membrane production was performed with the concentration of hexamethyldisiloxane being changed to form a silica-based separation layer, and the elemental composition on the surface of the formed silica-based separation layer was quantified.

### (Gas Transmission)

The gas transmission of the obtained gas separation membrane was evaluated using pure gas (CO₂, CH₄). The upstream side of the gas separation membrane was pressurized from atmospheric pressure to a slight pressure (100 to 110 kPaG), and the transmit side having a known volume was evacuated under vacuum. Then, the gas separation membrane was separated from the evacuation system, and the gas transmittance was determined from the pressure increase rate (a pseudo-stationary method was used).

TABLE 1

| | Polymer substrate | | | | | | | | | |
|---|---|---|---|---|---|---|---|---|---|---|
| | (support) | | Intermediate layer | | | Separation layer | | | | |
| | | CO₂ | | | CO₂ | | Thickness (μm) | | | |
| | Trade | transmittance | Raw | Thickness | transmittance | Number of | First layer | Second layer | O/Si | Content of Si atom |
| | name | (GPU) | material | (μm) | (GPU) | layers | separation | separation | (surface) | and oxygen atom |
| Example 1 | CF-30K | 74500 | PDMS | 3 | 1500 | 2 | 400 | 800 | 1.48 | First separation |
| | | | | | | layers | | | | layer < Second |
| | | | | | | | | | | separation layer |
| Example 2 | CF-30K | 74500 | PDMS | 2 | 2200 | 2 | 400 | 800 | 1.48 | First separation |
| | | | | | | layers | | | | layer < Second |
| | | | | | | | | | | separation layer |
| Comparative | CF-30K | 74500 | — | — | — | 2 | 400 | 800 | 1.48 | First separation |
| Example 1 | | | | | | layers | | | | layer < Second |
| | | | | | | | | | | Separation layer |
| Comparative | CF-30K | 74500 | PDMS | 3 | 1500 | 1 | — | | — | Center of |
| Example 2 | | | | | | layer | | | | intermediate layer < |
| | | | | | | | | | | Surface of |
| | | | | | | | | | | separation layer |
| Comparative | CF-30K | 74500 | PDMS | 5 | 670 | 1 | 400 | | 1.24 | Equal in layer |
| Example 3 | | | | | | layer | | | | |
| Comparative | CF-30K | 74500 | PDMS | 5 | 670 | 1 | 800 | | 1.48 | Equal in layer |
| Example 4 | | | | | | layer | | | | |
| Comparative | NIR- | 1050 | — | — | — | 2 | 400 | 800 | 1.48 | First separation |
| Example 5 | 7410 | | | | | layers | | | | layer < Second |
| | | | | | | | | | | separation layer |
| Example 3 | CF-30K | 74500 | PDMS | 3 | 1500 | 2 | 400 | 800 | 1.48 | First separation |
| | | | | | | layers | | | | layer < Second |
| | | | | | | | | | | separation layer |
| Example 4 | CF-30K | 74500 | PDMS | 3 | 1500 | 2 | 400 | 800 | 1.69 | First separation |
| | | | | | | layers | | | | layer < Second |
| | | | | | | | | | | separation layer |

| | | Gas transmission | | | | | |
|---|---|---|---|---|---|---|---|
| | | C/Si | | 150° C. | | 25° C. | |
| | Separation layer | First | Second | CO₂ | | CO₂ | |
| | Content of | separation | separation | transmittance | CO₂/CH₄ | transmittance | CO₂/CH₄ |
| | carbon atom | layer | layer | (GPU) | transmittance | (GPU) | transmittance |
| Example 1 | First separation | 1.54 | 1.35 | 91 | 9.9 | 95 | 50 |
| | layer > Second | | | | | | |
| | separation layer | | | | | | |
| Example 2 | First separation | 1.54 | 1.35 | 316 | 12.8 | 270 | 37 |
| | layer > Second | | | | | | |
| | separation layer | | | | | | |
| Comparative | First separation | 1.54 | 1.35 | 627 | 3.5 | 530 | 4.4 |
| Example 1 | layer > Second | | | | | | |
| | separation layer | | | | | | |
| Comparative | Center of | — | — | 3.8 | 1.8 | — | — |
| Example 2 | intermediate layer > | | | | | | |
| | Surface of | | | | | | |
| | separation layer | | | | | | |
| Comparative | Equal in layer | 1.54 | — | 285 | 3.3 | — | — |
| Example 3 | | | | | | | |
| Comparative | Equal in layer | 1.35 | — | 119 | 3.7 | — | — |
| Example 4 | | | | | | | |
| Comparative | First separation | 1.54 | 1.35 | 40 | 6.8 | 22 | 7.1 |
| Example 5 | layer > Second | | | | | | |
| | separation layer | | | | | | |
| Example 3 | First separation | 1.54 | 1.35 | 183 | 17.8 | 160 | 32 |
| | layer > Second | | | | | | |
| | separation layer | | | | | | |
| Example 4 | First separation | 1.54 | 1.2 | 21 | 14.1 | 17.2 | 17 |
| | layer > Second | | | | | | |
| | separation layer | | | | | | |

TABLE 2

| | Production conditions | | | | | | | |
|---|---|---|---|---|---|---|---|---|
| | Discharge gas | | | | Flow rate | | Applied voltage | |
| | (vol %) | | Carrier gas | | (L/min) | | (kV) | |
| | First | Second | First | Second | First | Second | First | Second |
| | separation | separation | separation | separation | separation | separation | separation | separation |
| | layer | layer | layer | layer | layer | layer | layer | layer |
| Example 1 | N₂ (0.25) | N₂ (0.25) | Ar | Ar | 2.5 | 2.5 | 7 | 7 |
| Example 2 | N₂ (0.25) | N₂ (0.25) | Ar | Ar | 2.5 | 2.5 | 7 | 7 |
| Comparative | N₂ (0.25) | N₂ (0.25) | Ar | Ar | 2.5 | 2.5 | 7 | 7 |
| Example 1 | | | | | | | | |
| Comparative | N₂ (0.25) | — | Ar | — | 2.5 | — | 7 | — |
| Example 2 | | | | | | | | |
| Comparative | N₂ (0.25) | — | Ar | — | 2.5 | — | 7 | — |
| Example 3 | | | | | | | | |
| Comparative | N₂ (0.25) | — | Ar | — | 2.5 | — | 7 | — |
| Example 4 | | | | | | | | |
| Comparative | N₂ (0.25) | N₂ (0.25) | Ar | Ar | 2.5 | 2.5 | 7 | 7 |
| Example 5 | | | | | | | | |
| Example 3 | N₂ (0.25) | N₂ (0.25) | Ar | Ar | 2.5 | 2.5 | 7 | 7 |
| Example 4 | N₂ (0.25) | N₂ (0.25) | Ar | Ar | 2.5 | 2.5 | 7 | 7 |

| | Vapor deposition | | | | Concentration of | |
|---|---|---|---|---|---|---|
| | temperature | | Number of vapor | | hexamethyldisiloxane | |
| | ( ° C.) | | deposition cycles | | (ppm) | |
| | First | Second | First | Second | First | Second |
| | separation | separation | separation | separation | separation | separation |
| | layer | layer | layer | layer | layer | layer |
| Example 1 | 100 | 100 | 2 | 2 | 783 | 81 |
| Example 2 | 100 | 100 | 2 | 2 | 783 | 81 |
| Comparative | 100 | 100 | 2 | 2 | 783 | 81 |
| Example 1 | | | | | | |
| Comparative | 100 | — | 2 | — | — | — |
| Example 2 | | | | | | |
| Comparative | 100 | — | 2 | — | 783 | — |
| Example 3 | | | | | | |
| Comparative | 100 | — | 2 | — | 81 | — |
| Example 4 | | | | | | |
| Comparative | 100 | 100 | 2 | 2 | 783 | 83 |
| Example 5 | | | | | | |
| Example 3 | 150 | 150 | 2 | 2 | 783 | 83 |
| Example 4 | 100 | 100 | 3 | 3 | 783 | 54 |

### INDUSTRIAL APPLICABILITY

The gas separation membrane of the present invention can be used as a separation membrane that transmits and separates a specific gas from a mixed gas.

### DESCRIPTION OF REFERENCE SIGNS

1 Separation layer membrane production apparatus
2 Discharge gas cylinder
3 Carrier gas cylinder
4 Bubbler
5 Plasma generator
6 Discharge unit
7 Polymer membrane substrate having intermediate layer

1. A gas separation membrane comprising an intermediate layer on a polymer membrane substrate and a separation layer on the intermediate layer, wherein
the intermediate layer has a non-porous structure,
the separation layer is a silica-based separation layer, and
the silica-based separation layer has a different chemical composition or layer structure in a thickness direction.

2. The gas separation membrane according to claim 1, wherein in the silica-based separation layer, a rate of an inorganic structure increases from the intermediate layer side toward the other side in the thickness direction.

3. The gas separation membrane according to claim 1 or 2, wherein in the silica-based separation layer, a content of an Si atom and an oxygen atom increases and a content of a carbon atom decreases from the intermediate layer side toward the other side in the thickness direction.

4. The gas separation membrane according to any one of claims 1 to 3, wherein O/Si, which is a ratio of the number of oxygen atoms to the number of Si atoms on a surface of the silica-based separation layer, is less than 1.7.

5. The gas separation membrane according to any one of claims 1 to 4, wherein the silica-based separation layer has a multilayer structure.

6. The gas separation membrane according to claim 5, wherein the silica-based separation layer includes at least a first separation layer laminated on the intermediate layer and a second separation layer laminated on the first separation layer, a content of an Si atom and an oxygen atom in the second separation layer is higher than a content of an Si atom and an oxygen atom in the first separation layer, and a content of a carbon atom in the second separation layer is lower than a content of a carbon atom in the first separation layer.

7. The gas separation membrane according to claim 6, wherein C/Si, which is a ratio of the number of carbon atoms to the number of Si atoms in the first separation layer, is 1.5 or more and 1.8 or less, and C/Si, which is a ratio of the number of carbon atoms to the number of Si atoms in the second separation layer, is 1.0 or more and less than 1.5.

8. The gas separation membrane according to any one of claims 1 to 7, wherein a raw material of the silica-based separation layer is a volatile organosilicon compound.

9. The gas separation membrane according to any one of claims 1 to 8, wherein the intermediate layer contains polysiloxane.

10. The gas separation membrane according to claim 9, wherein the polysiloxane is polydimethylsiloxane.

11. The gas separation membrane according to any one of claims 1 to 10, wherein CO₂ transmittance at 25° C. is 90 GPU or more.

12. The gas separation membrane according to any one of claims 1 to 11, wherein a CO₂/CH₄ transmittance ratio at 25° C. is 15 or more.
